(19) United States
(12) Patent Application Publication
(10) Pub. No.: US 2007/0193575 A1
(43) Pub. Date: Aug. 23, 2007

(54) Container having a heat concentration assembly securely formed on a bottom of the container

(76) Inventor: Horng-Yi Jan, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/358,509

(22) Filed: Feb. 21, 2006

(51) Int. Cl. A47J 27/02

(52) U.S. Cl. 126/390.1

(57) ABSTRACT

A container includes a body and a heat concentration assembly securely formed on the bottom face of the body. The heat concentration assembly is composed of multiple protrusions formed on the bottom face of the body. The protrusions on the bottom face of the body absorb heat from a heating device and deliver the absorbed heat directly to the bottom face of the body to reduce heating time.

### BACKGROUND OF THE INVENTION

1. Field of the Invention

The present invention relates to a container, and more particularly to a container having thereunder a heat concentration assembly securely formed on a bottom of the container so that when the container is heated, the heat concentration assembly is able to concentrate heat to an object inside the container to reduce heating time.

2. Description of the Prior Art

When a pot or a pan is placed on top of an oven or a stove, the heat from the stove increases the temperature of the pot, which indirectly cook the food inside the pot. It is known by theory that the heat to the pot is transmitted to the food due to gradual heat conduction from the bottom of the pot and then to the peripheral side face of the pot. During the heat conduction, a lot of heat loss occurs due to air convection, which means a portion of the fuel is not effectively utilized to increase the temperature of the pot and a long period of time to heat the pot is required so as to prepare the food inside the pot.

To overcome the shortcomings, the present invention tends to provide an improved container to mitigate the aforementioned problems.

### SUMMARY OF THE INVENTION

The primary objective of the present invention is to provide an improved container having a heat concentration assembly formed on the bottom of the container to effectively increase the temperature of the container when the container is heated.

Another objective of the present invention is that the heat concentration assembly includes multiple elongated fins and a ring. The fins are securely formed on the bottom face of the container and the ring is securely attached to bottom faces of each of the fins. Therefore, when the container is heated, the divergently formed fins on the bottom of the container are able to concentrate heat to the bottom face of the container so that the heating duration is reduced.

Still another objective of the present invention is that the ring attached to the bottom faces of the fins is able to prevent accessories of the heating device from being caught in a gap between two adjacent fins.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the container of the present invention;

FIG. 2 is a schematic side plan view showing the application of the container on top of a heating device;

FIG. 3 is a perspective view of the second embodiment of the container of the present invention;

FIG. 4 is a perspective view of the third embodiment of the container of the present invention; and

FIG. 5 is a perspective view of the fourth embodiment of the container of the present invention.

### DETAILED DESCRIPTION OF THE PREFERRED EMBODIMENT

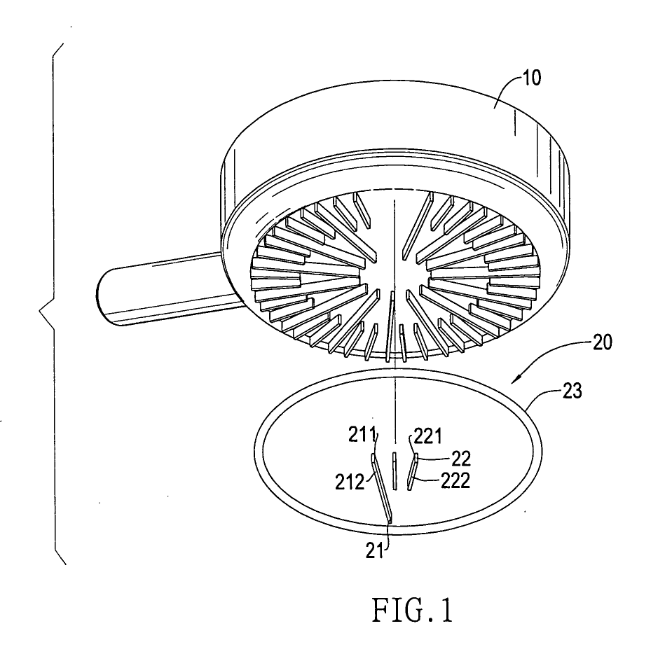

With reference to FIG. 1, it is noted that the container in accordance with the present invention includes a body (10) configured to receive therein an object such as food or the like. A heat concentration assembly (20) is provided to the body (10) and has multiple fins, the first fins (21) and the second fins (22), and a ring (23).

The fins are securely and divergently attached to a bottom face of the body (10) from a center of the bottom face of the body (10). And it is noted that in every two first fins (21), a second fin (22) is arranged such that the second fin (22) is alternately formed to the bottom face of the body (10) in every two first fins (21). Each first fin (21) has a length shorter than that of the second fin (22). Each of the first fins (21) and of the second fins (22) have a top side face (211,221) and a bottom face (212,222) both of a dimension smaller than a dimension of a side face sandwiched by the top side face (211,221) and the bottom face (212,222).

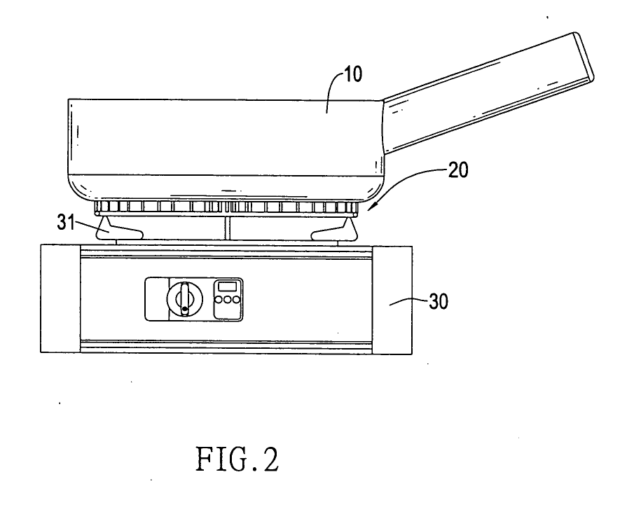

With reference to FIG. 2, it is noted that when the container of the present invention is placed on top of a heating device (30), i.e. a gas burner, a support (31) on top of the heating device (30) is securely engaged with the ring (23) of the heat concentration assembly (20) such that the support (30) will not be stuck between a gap defined between two adjacent fins. Thereafter, the divergently formed fins, the first fins (21) and the second fins (22), on the bottom of the body (10) are able to concentrate heat from the heating device (30) to reduce the regular heating time.

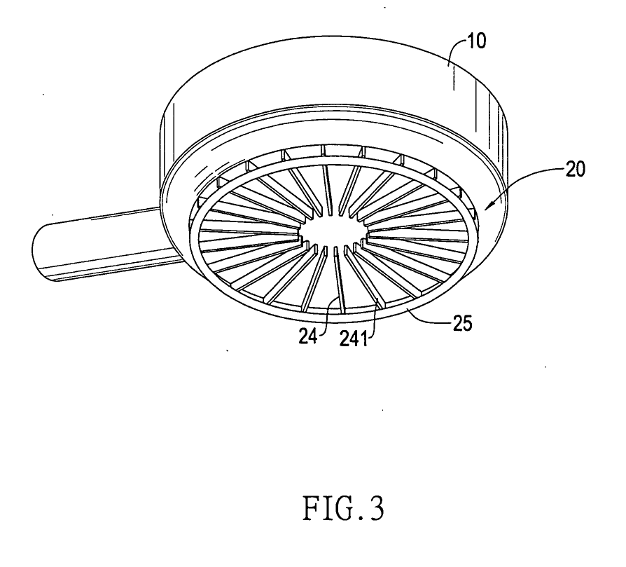

With reference to FIG. 3, it is noted that the fins (24), originally the first fins (21) and the second fins (22) in the first embodiment, are changed to have the same length and the ring (25) is attached to bottom faces (241) of the fins (24).

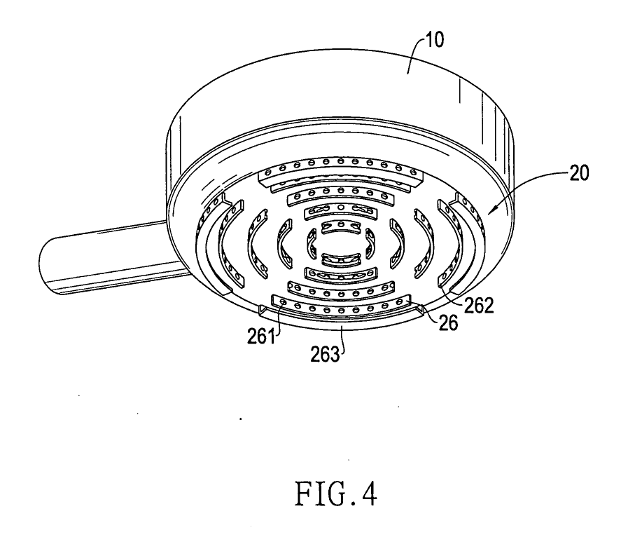

With reference to FIG. 4, it is noted that the heat concentration assembly (20) in this embodiment is composed of multiple concentrically and intermittently formed arcuate fins (26). Each arcuate fin (26) is elongated and has multiple through holes (261) defined through a side face thereof to facilitate air convection below the body (10) of the container of the present invention. In addition, each of the outermost arcuate fins (26) is provided with a skirt (263) extending from a free peripheral edge (262) of the outermost arcuate fin (26) to function as a ring as described in the previous embodiment.

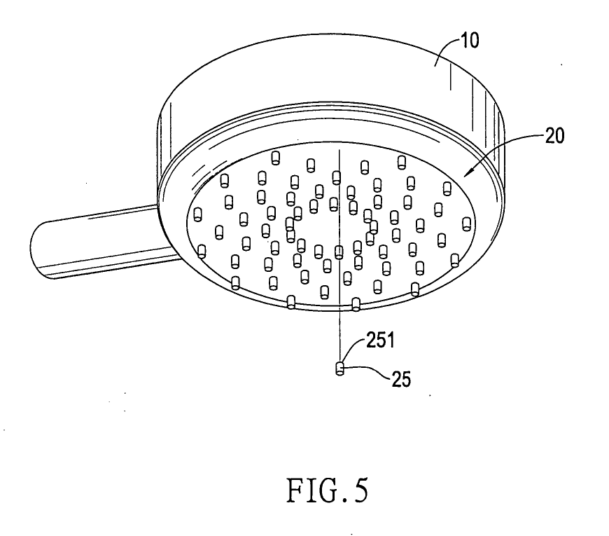

With reference to FIG. 5, it is noted that the heat concentration assembly (20) of the present invention is composed of multiple protrusions (25) firmly formed on the bottom face of the body (10) of the container of the present invention.

From the aforementioned description, it is concluded that the heat concentration assembly (20) of the present invention is able to absorb heat from a heat source and deliver the heat directly to the bottom of the container body so that the heating duration time is reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are 6 expressed.

What is claimed is:

1. A container comprising:
a body with a bottom face; and
a heat concentration assembly composed of multiple protrusions formed on the bottom face of the body,
whereby the protrusions on the bottom face of the body absorb heat from a heating device and deliver the absorbed heat directly to the bottom face of the body to reduce heating time.

2. The container as claimed in claim 1, wherein the protrusions are divergently formed on the bottom face of the body.

3. The container as claimed in claim 2, wherein the protrusions are composed of first protrusions respectively having a first length and second protrusions respectively having a second length longer than that of the first length of the first protrusions.

4. The container as claimed in claim 2 further comprising a ring formed on a bottom of each of the protrusions.

5. The container as claimed in claim 3 further comprising a ring formed on a bottom of each of the protrusions, wherein each second protrusion is alternately arranged in every two first protrusions.

6. The container as claimed in claim 1, wherein the protrusions are arcuate and concentrically formed on the bottom face of the body, each protrusion has multiple through holes defined through a side face of the protrusion and each outermost protrusion is provided with a skirt formed on a peripheral free edge of the outermost protrusion.
